(19) United States
(12) Patent Application Publication
(10) Pub. No.: US 2016/0345047 A1
(43) Pub. Date: Nov. 24, 2016

(54) METHOD AND APPARATUS FOR SELECTING A SECONDARY MEDIA

(71) Applicant: Orange, Paris (FR)

(72) Inventors: Mathieu Rivoalen, Lannion (FR); Gwenael Le Goff, Lannion (FR)

(21) Appl. No.: 15/159,410

(22) Filed: May 19, 2016

(30) Foreign Application Priority Data
May 22, 2015 (FR) 1554656

(51) Int. Cl. H04N 21/422; H04N 5/44; H04N 21/61; H04N 21/482; H04N 21/472

(52) U.S. Cl. CPC H04N 21/42204; H04N 21/482; H04N 21/47217; H04N 21/6125; H04N 21/6112; H04N 5/4403

(57) ABSTRACT

A method is provided for selecting secondary multimedia contents associated with a main multimedia content being played back by a playback device. The contents are stored in a network and controlled by a remote control device. The method includes: playing back the main multimedia content on the playback device; detecting an action on the remote control device; accessing the secondary content corresponding to the action; and playing back the secondary content with the main content on the playback device. The act of accessing the secondary content is preceded by an act of obtaining data for matching the action on the remote control device with the secondary content.

### TECHNICAL FIELD

The present invention relates to the field of playing back data corresponding to multimedia contents.

The term “multimedia content” is used to mean any content including at least one media of audio, video, or text type or more generally any digital type, and is referred to below as “content”. The terms “multimedia content channel”, or “TV channel”, or more simply “channel” are used to designate a succession of such contents in time.

The invention applies to playing back such contents on a terminal having a screen and connected to a network, regardless of whether the network is of local or wide area type and whether the content is broadcast (a network of the digital video broadcast (DVB) type) or transmitted via an Internet type network. “Playback” generally means displaying the content on a screen of such a terminal or playing back its sound.

### STATE OF THE ART

In the field of making available multimedia contents, such as films, TV programs, music, etc., on a user's playback terminal (TV, PC, tablet, etc.), the contents that are proposed are accompanied by ever more varied options: language selection, subtitle selection, content enrichment, content interaction, etc.; and this applies regardless of the origin of the contents or how they are made available (digital TV broadcast over a wide area network e.g. digital terrestrial TV (DTTV) or asynchronous digital subscriber line (ADSL), or content delivered or broadcast in a local network via an internal communications server or “media center”, in a wide area network from a streaming server, etc.).

In order to make these options easier to select, applications for managing such contents generally propose interactive menus that are available by being displayed on the playback device, e.g. a TV. One known way of accessing that type of menu relies on using a remote control: a list of options available for the current content is displayed at the request of the user. To make the menu appear, while still continuing to view the content, the user presses on a specific key of the remote control (e.g. “menu”). Thereafter the user can browse various submenus by causing options to scroll, typically by means of “up” and “down” arrows on a remote control cursor pad. The remote control also has means for selecting an option, e.g. an “ok” key. In this context, the user needs to select the menu, find the appropriate submenu by browsing (e.g. in order to select subtitle language), and then select the appropriate parameter (e.g. Spanish).

This is awkward and time-consuming for the user of such a system that relies on browsing through menus, particularly if the user has no control over scheduling and merely desires to activate a subtitle track without making complicated detours via the browser interface.

While this is going on, the content continues to be played back on the TV. The time needed for selecting the desired submenu thus has the consequence of content being played back without the desired subtitling and diverts the user's attention to moving through the menus, as opposed to the content being played back.

The invention offers a solution that avoids the drawbacks of the state of the art.

### THE INVENTION

To this end, in a functional aspect, the invention provides a method of selecting secondary multimedia contents associated with a main multimedia content being played back by a playback device, the contents being stored in a network and controlled by a remote control device, the method comprising the following steps:
playing back the main multimedia content on the playback device; detecting an action on the remote control device;
accessing the secondary content corresponding to said action; and
playing back the secondary content with the main content on the playback device;

the method being characterized in that accessing the secondary content is preceded by a step of obtaining data for matching the action on the remote control device with the secondary content.

Thus, the invention provides the advantage of making it simple to select an option associated with the multimedia content that is being viewed. This content, referred to as “main” content, may correspond for example to a film taken from a DVD, a TV channel, a multimedia stream stored in the wide area network (WAN), or in the user's local area network (LAN), etc. An option associated with such a content may for example be the language of the sound track, the language of the associated subtitles, selecting additional information about the content, an option for voting on the content, configuring the audio mode (multichannel, stereo, . . . ), etc.

Advantageously, a specific action on certain keys of the remote control enables the user to select such an option without navigating through the menus. The action may be identified by a string of inputs made by pressing on the keys of the remote control, e.g. “S, T, F, R” for requesting subtitles (“ST”) in French (“FR”), or the string “A, D, 5, 1” for audio playback (“AD”) in multichannel 5.1 mode, etc. There is therefore no need for the user to browse through a complex menu in order to select an option. Selecting the secondary content is thus made simpler and also quicker, which is advantageous when the main content continues to run.

In a particular implementation of the invention, the method as described above may also be characterized in that the action on the remote control device is selecting at least two keys of the remote control.

In this implementation, the user needs to press at least two keys in succession in order to select the secondary multimedia content. This makes it possible to give the user the option, particularly if the user has a remote control with an alphanumeric pad, of selecting a string of characters that is meaningful relative to the selected option, e.g. “subtitles” corresponds to successively selecting the keys carrying the letters “S, T” in order to announce selecting subtitle mode. In another example, a change of language to English would give rise to “L” followed by “E,N”, and switching to 5.1 audio to “A,D”, “5,1”.

In a variant of this particular implementation of the invention, a method as described above is also characterized in that two keys on the remote control must be selected in succession within a predefined maximum duration.

Advantageously, this variant enables the user to select two successive keys within a time interval of limited maximum duration, e.g. limited to one second. Thus, in the context of an alphanumeric string, all of the characters need to be input in succession while complying with this maximum time interval for input between two characters; the complete string (“S, T, F, R”) is interpreted only at the end of input, i.e. when the last time interval (after inputting the last key, “R”) has elapsed, which means that the user has finished inputting and that the input can thus be analyzed.

In another variant of this particular implementation of the invention, that may be implemented as an alternative to or together with the above variant, a method as described above is also characterized in that at least one selected key corresponds to secondary content type data and enables the action on the remote control device to be matched with the secondary content.

In this implementation, the user needs to act on at least one key in order to select the type of secondary multimedia content. The term “type of secondary content” is used to mean a category to which the secondary content relates: subtitles, audio track, metadata about the content, video inlay, etc. This makes it possible to set the type of content that can be selected. For example, selecting subtitles corresponds to making a selection by pressing in succession on the keys carrying the letters “S” and then “T” in order to specify subtitle selection mode, followed by “F, R” on the remote control, thereby producing the string “STFR” for SubTitles in FRench. Selection in this example is thus made up of a preamble defining the type of secondary content (“ST”=subtitle) and then selecting a possible element from all of the category elements for this type. Thus, “FR” is one possible selection in the type “ST”, as are, in the same manner “EN”, “ES”, etc., referring to a specific language for the subtitles. In another example, changing language to English may be represented by “L” for the type (Language) and “EN” for the language (English); switching to 5.1 audio playback is represented by “AD” for the type (AuDio) and “51” for the selected type of audio (5.1).

In a second particular implementation of the invention that may be used as an alternative to or together with the first, a method as described above is also characterized in that the data for matching the action on the remote control device with the secondary content to be selected is stored in a correspondence data structure in memory in at least a terminal of the network.

Advantageously, this implementation enables the manager of a terminal of the local network (e.g. the TV decoder associated with the TV, or the home gateway of the local network, etc.) or of the wide area network (server in the cloud, etc.) to have a simple correspondence table in memory that enables the secondary content selected on the remote control (“ST, FR”) to be matched with the secondary content itself, as though the user were browsing in a menu.

In a variant of this particular implementation of the invention, a method as described above is also characterized in that the correspondence data structure in the memory of the terminal is modified by the user by means of an interface.

By means of this variant, the user of a playback device can give settings to various keys of the remote control as appropriate: the user can control the correspondence table that is stored in the memory of a terminal, and preferably of the local network, and in particular of the TV decoder associated with the TV. A graphics interface is made available to the user on the playback screen, e.g. when initialized in the terminal (TV decoder) in order to set the key(s), or a succession of keys, for pressing when selecting a secondary content. Subsequently, if the action selected by the user while a main content is playing corresponds to an action that has already been set (e.g. pressing the “red” key on the remote control), then that action selects a secondary content (e.g. it selects an audio track in Spanish).

In this way, access to the desired option can be made very fast: depending on the user's habits, the user can set up a combination and/or a succession of rapidly accessible keys (e.g. a single press on the red key, or simultaneous or successive presses on the red key and the green key) that can be performed quickly and that is easy to remember.

Naturally, this variant assumes that the table in memory can be modified by the user and that it is therefore situated in a rewritable memory of the terminal (flash, random access memory (RAM), etc.).

In a hardware aspect, the invention also provides a device for selecting a secondary multimedia content associated with a main multimedia content being played back on a playback device, the contents being stored in a network and being capable of being controlled by a remote control device, the device for selecting content comprising the following modules:
a playback module for playing back the main multimedia content on the playback device;
a detection module for detecting an action on the remote control device;
an access module for accessing the secondary content corresponding to said action; and
a playback module for playing back the secondary content in association with the main content;

the device for selecting content being characterized in that the secondary content access module is suitable for obtaining data for matching the action on the remote control device with the secondary content that is to be played back.

The term “module” may relate equally to a software component or to a hardware component or to a set of hardware and software components, and a software component may itself correspond to one or more computer programs or subprograms or, more generally, to any element in a program suitable for performing a function or a set of functions as described for the modules in question. In the same manner, a hardware module may correspond to any element or set of elements (or hardware) suitable for performing a function or a set of functions for the module in question (integrated circuit, smart card, memory card, etc.).

In another hardware aspect, the invention also provides a communication terminal including such a device.

Advantageously, in this aspect, the communication terminal, e.g. a digital decoder (or set-top box (SIB)) associated with the playback device is suitable for receiving instructions from the remote control and for converting them directly into an action of downloading the secondary content that is to be associated with the main content. In this embodiment, the remote control is preferably the native remote control, i.e. the remote control that the manufacturer of the equipment (SIB) associates therewith for controlling it.

In another hardware aspect, the invention also provides a communication terminal as defined above, characterized in that it further includes a receive module suitable for receiving an action from the playback device, said action being transmitted from a remote control device associated with the playback device.

In this embodiment, the remote control of the playback terminal is typically that of the TV connected to the digital decoder (SIB). For example, the decoder sends the decoded main content to the TV via an HTMI connection, and playback is performed in the form of a display and sound on the TV. Advantageously in this embodiment, the TV receives information from its remote control (e.g. the user has pressed the red button), adapts that information, and then forwards it to the decoder (SIB). The actions made on the TV remote control are thus forwarded to the terminal via the playback device, and no longer via its own remote control. This is naturally advantageous if the user uses the TV remote control and not the decoder remote control.

An NTMI type connection may convey such signals from the TV to the TV decoder.

HDMI (which stands for high definition multimedia interface) type connections are designed firstly to convey digital contents comprising an image and sound at a high data rate (in high definition) and in reliable manner. It is nowadays very wide spread and is to be found on most video terminals on the market (TVs, DVD readers, computers, etc.). Advantageously, the HDMI-CEC (consumer electronics control) specification can also be used to control the connected appliances. One of the pins of the HDMI interface is then dedicated to a set of control functions between appliances. When it is used by the manufacturer, the CEC specification allows a variety of control functions to be performed on connected pieces of equipment and in particular, when the connected appliances are compatible, it makes it possible to set up both-way communication between them and to string various commands (play content, fast forward, pause, mute, switch to next program, change program, etc.). In the context of the invention, it can be used for conveying the key codes of the remote control for association with a secondary content selection, as described above (e.g. “S, T, E, S” for subtitles in Spanish).

In another hardware aspect, the invention also provides a computer program suitable for being performed in a device for selecting multimedia content as defined above, the program including code instructions that, when the program is executed by a processor, perform the steps of the selection method.

The selection device and the computer program present characteristics and advantages analogous to those described above with reference to the selection method.

In yet another hardware aspect, the invention provides a processor-readable data medium containing a program including program code instructions for executing the steps of the above-defined method.

The invention can be better understood on reading the following description given by way of example and made with reference to the accompanying drawings.

### THE FIGURES

FIG. 1 shows an embodiment of the invention in the context of a local network having a service for consuming multimedia contents;

FIG. 2 shows a remote control for a playback device in accordance with the invention of FIG. 1;

FIG. 3 shows the hardware architecture of a digital decoder in an embodiment of the invention; and

FIG. 4 is a flow chart showing the various steps of the method in an implementation of the invention.

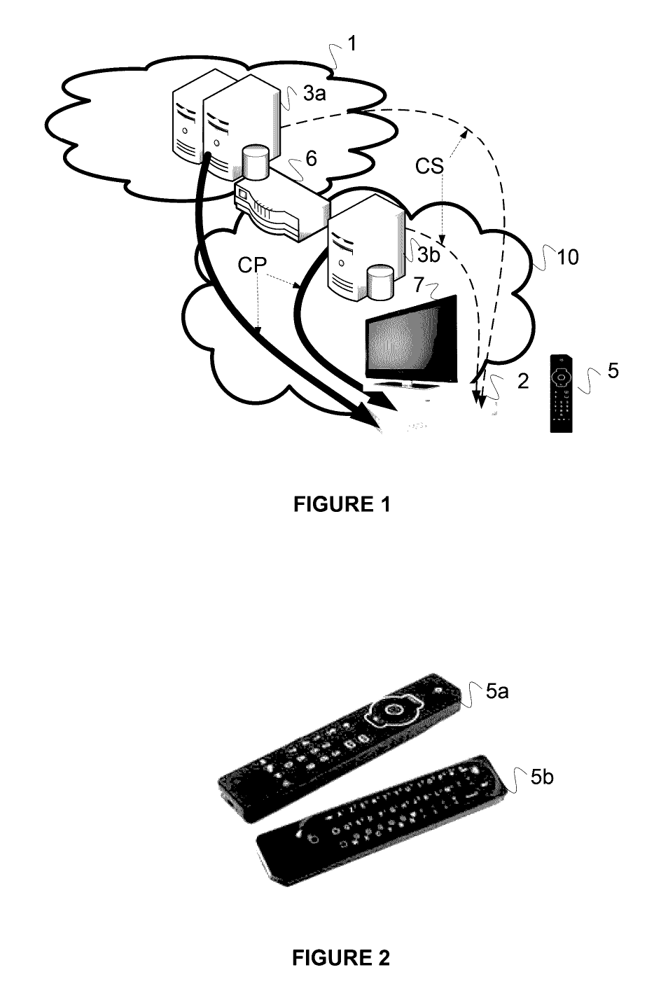

FIG. 1 shows an embodiment of the invention in the context of a local network.

It should be recalled that a local network, also known as a home network, is a computer network that connects together, with or without wires, terminals (computers, printer peripherals, playback peripherals, storage peripherals, etc.) in a home, which terminals are suitable for communicating with one another. A home network generally includes router equipment (6), also commonly referred to as a home gateway, or service gateway, i.e. an intermediate element that redirects or “routes” data packets between the various terminals and the networks connected thereto (wide area network (1) and local network (10)). Such a home network often connects the various terminals by using wired connections or radio type connections, e.g. WiFi (“wireless fidelity”). In this example, the network (10) is of the Internet type. The service gateway (6) has a WiFi communication function that enables it to communicate wirelessly with the terminals of the local network, and a wired connection, e.g. an ADSL connection, that enables it to communicate with the wide area Internet network (WAN, 1).

The term “terminal device” or more simply “terminal” is used to cover any device capable of connecting to the gateway (6) in the context of the local network, such as a computer or a TV type device (TV, 7), a personal computer (PC), a smart phone, or more generally any device suitable for communicating with or without wires with the service gateway.

Among these terminals, the device (3b) shown in FIG. 1 in this example is a storage device of the user, also known as network attached storage (NAS) covering a set of hard disks in an appliance that also has network functions.

The terminal (2) is a device for receiving and decoding multimedia contents, referred to below as a set-top box (STB). The STB (2) is connected to the local network via the service gateway (6). The terminal (2) is associated with an infrared (IR) or radio frequency (RF) remote control (5) suitable for controlling the STE (2) remotely, and thus for controlling the TV (7) connected thereto, which TV has a display screen and loudspeakers for playing back multimedia contents. The STE (2) includes means for accessing channels and means for channel hopping (i.e. browsing from one channel to another) on the wide area network (1) via the service gateway. It also includes means for accessing multimedia contents of the local network situated for example in the NAS (3b), and means for accessing options for the channels and/or contents, which options correspond in this example to so-called “secondary” contents, as contrasted to the main content as conveyed by the audiovisual data from the selected content or TV channel.

The STB (2) and the NAS (3b) together provide the user with a multimedia content consumption service or “media center”, i.e. a system giving the user access to the multimedia content of the local network.

In a first embodiment, the user of the local network (10) seeks to obtain audiovisual content that is to be found for example in the NAS (3b), together with subtitles in Spanish, likewise stored in the NAS (3b) in the form of a file.

In another variant, the user of the STE (2) has subscribed to a package of TV channels by ADSL, e.g. stored on the server (3a) of an operator in the wide area network.

In yet another variant, the multimedia contents may be situated on an external storage peripheral (3a) of the user (Cloud).

At this point it is assumed that the user is initially watching a “main” content, referenced CP (or alternatively a broadcast channel CRP) on the screen of the display device 7. For this purpose, the STB (2) receives, decodes, and possibly unscrambles the content CP. This content is conventionally associated with a certain number of options, corresponding to secondary contents (files, streams, etc.) that are synchronized with the main content and that can be decoded and played back simultaneously:
an audio stream (AD) corresponding to a given language (L) for sound playback; the audio stream (AD) may be selected from EN (English), FR (French), ES (Spanish), etc.; and
a subtitle stream, corresponding to a given language, that may conventionally be played back in a small window at the bottom of the screen of the TV device (7). The optional subtitle stream is selected from EN (English), FR (French), and ES (Spanish).

This list of options is naturally not limiting. Mention may be made to numerous other options for associating with the main content, for example audio description content (for the visually impaired), additional data content (actors, summary of scenes, making-of . . . for a film), contents including interactive data for interacting with the main content (voting, connection to a community site, etc.), olfactory contents, additional audio contents, etc.

In this embodiment, the user is French and is learning Spanish. The user would thus like to listen to the content in French or in English while having subtitles available in Spanish. In order to avoid tediously making selections by browsing through menus on the screen (calling up the menu, addressing submenus, arrows for moving across the screen, confirm button, etc.), and in particular in order to avoid doing this each time a program is changed or each time a content viewing or TV session is restarted, this embodiment of the invention enables the user to select options directly using the remote control: pressing a certain combination of keys while the main content is being read enables the user to benefit immediately from a display of subtitles in Spanish.

For this purpose, the user preferably uses the alphanumeric keys on the remote control, which do not serve directly for selecting a content. Specifically, when a content (e.g. channel 1) is current, selecting certain other keys (e.g. the key 3) can lead to an unwanted changeover of the content (specifically to channel 3). In other words, certain keys of the remote control are contextually not useful and possibly even detrimental.

It is assumed that the remote control has function keys for selecting letters of the alphabet, which are useful in this context. The user inputs a string of letters e.g. as specified in a user manual: subtitles may be selected by acting in succession on the keys carrying the letters “S” and “T” defining the type of secondary content, followed by “E” and “S” in order to select an element within this type (“STES” for subtitles in Spanish). Acting on a key or combination of keys while the main content is playing leads to accessing a correspondence table in the memory of the STE, where the characteristics of the secondary content are selected, e.g. reading in the table of type “ST” indicates the type of secondary content (subtitles) and reading the string “ES” indicates selecting Spanish. In another example, pressing on the keys “L” followed by “E,N” means selecting an English audio track, and is understood as such by the STE in order to select the file or audio data corresponding to the English language.

FIG. 2 shows a remote control (5) of an STB (or alternatively of a home gateway or of a TV) in compliance with the embodiment of FIG. 1.

In this example, the remote control has two faces, one face (5a) is used in particular for inputting digits, while the other face (5b) presents an alphabetic input pad. Naturally, any other type of remote control could be used, in particular a remote control having only one face, providing it makes it possible to use combinations of keys to input letters or digits (also known as “system T9”).

In this embodiment, it is assumed that an action is made up of two successive presses on alphanumeric characters of the remote control:

1) A preamble indicating the type of option, and thus of secondary content, e.g.:
ST=subtitle
L=language
AD=audio description.

2) For certain types (ST and L in the above example), a second character string, input after the first, is to correspond with a language in compliance with the ISO639-1 or ISO639-2 standard (where ISO 639 is an international standard defining codes for representing the names of languages; languages are represented by a single code made of two or three letters, e.g. “ro”, “rom”, and “rou” are associated with Rumanian).

3) Together, these two indications (preamble and user selection) constitute an action.

An example of such a table (T) in the memory of the STB is shown below:

TABLE 1
An example of a correspondence table (T) in the
memory of the device associated with the remote control

| Type | Meaning | Selection | Resulting action |
|---|---|---|---|
| L | Language | “E,N” | Select English |
| | (LG) | | |
| ST | Subtitles | “E,N” | Select English |
| | (ST) | | subtitles |
| AD | Audio | 51 | Select a 5.1 sound |
| | | | system |
| ST | Subtitles | — | Activate/deactivate |
| | (ST) | | default subtitles |
| | | | (first available |
| | | | track) |

It is also desirable to have control over the inputting of the option string over time: in this example, if after a predefined time interval, e.g. 1 second, the user has not input two alphanumeric characters forming part of the selection (“S, T, F, S”), or if the information that has been input is not valid (e.g. the language code is not correct), then the action is not confirmed.

In a variant, certain actions may be predefined by the user. For example, a graphics interface may be proposed to the user during a prior step of configuring the keys of the remote control, enabling the preferences of the user of the STB to be stored and associated with particular actions on various keys. For example, a table such as the table given below may be stored in a modifiable memory of the communications subtitles (STB, 2) and modified by the user when making use of the graphics interface (e.g. by means of a menu).

TABLE 2
Example of a personalizable correspondence table
(T) in the flash memory of the device associated with the
remote control

| Type | Meaning | Selection | Default |
|---|---|---|---|
| Blue key (B) | Language (LG) | “E,N” | FR |
| Yellow key (Y) | Subtitles (ST) | “E,N” | ES |
| Green key (G) | ST = LG | | |
| Red key (R) | ST = ES | | |

In this table, which is given by way of example, four keys of the remote control are predefined:
B corresponds to the language option, and thus to selecting the language secondary content; if no action follows, then the language by default is selected (FR);
Y corresponds to the subtitle option; if no action follows, the language by default is selected (ES);
G sets the subtitle to the same language as the audio track (ST=LG);
R sets the subtitles to Spanish (ST=ES).

Naturally, any combination within the confidence of the person skilled in the art can be envisaged.

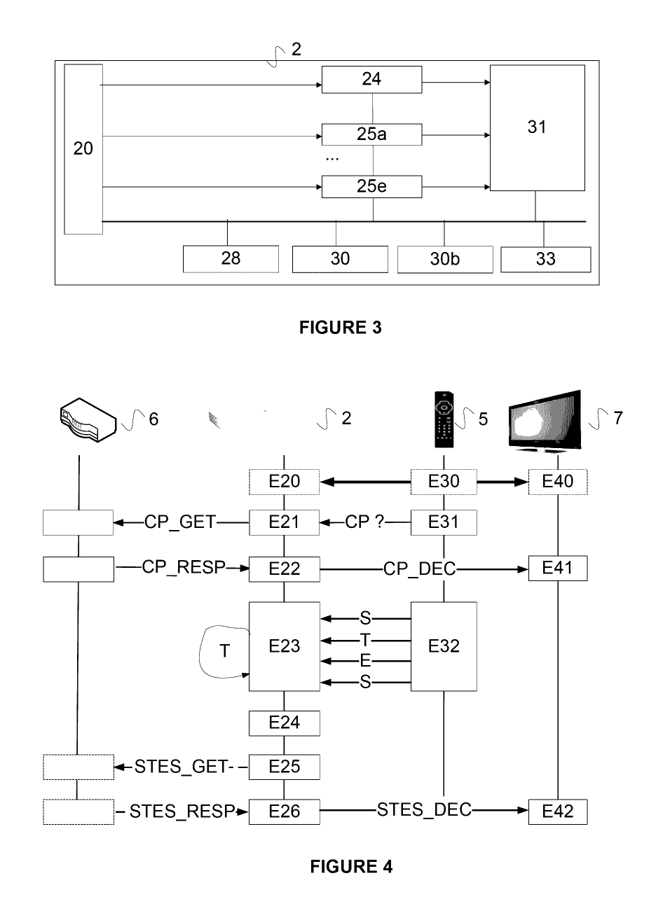

FIG. 3 shows the hardware architecture of a digital decoder (STE, 2) in an embodiment of the invention.

The STB 2 comprises:
an interface 20 for connection to the service gateway (6) and including in particular a transmit module and a receive module;
an unscrambling module, a demultiplexing module (in particular for multiplexed channels streams) for managing multicast stream reception, etc., not shown;
a module 24 for decoding a main audiovisual stream/content (AV);
modules 25A-25E for decoding secondary streams/contents;
a module 28 containing an infrared receiver associated with a block for interpreting IR commands coming from the remote control and/or a radio frequency receiver associated with a block for interpreting RF commands coming from the remote control 5;
a flash memory 30 that is not rewritable by the user, and that contains in particular the correspondence table that makes it possible to associate a preamble (“S,T”, “L”) with a user selection (“S,T”) as described with reference to FIG. 2 (Table 1);
a memory 30b that is rewritable by the user, containing the settable correspondence table enabling a key (or a combination of keys) to be associated with a user selection as described with reference to FIG. 2 (Table 2);
conventionally, a set of terminal memories (RAM, read-only memory (ROM), registers, etc.) containing in particular information about the available multimedia contents and all of the parameters needed to access a main content (multicast stream address, http address of a unicast stream, etc.) or secondary content (multicast stream address, http address of a subtitle unicast stream, etc.);
a video planning module 31 for the audio, video, and graphics signal that is to be sent to the display device 7, together with a module for sending an audio and video signal to the display device 7, e.g. of the HDMI type, and for receiving control signals coming from the payback device (HDMI/CEC). The video planning module 31 includes a graphics processor. It serves to establish a video plan on the basis of contents, streams supplied by the decoder modules, as a function of predefined configuration settings (sound used, added graphics elements, etc.) and to control the display on a screen, specifically the screen of the TV 7 in this example. It therefore serves to plan the video, audio, and graphics signal for sending to the display device and to control the display. It incorporates an appropriate function for inserting secondary contents (of subtitle type) in the main content viewed on the screen at a different location; and
a central control unit (UC or CPU) 33, to which all of the elements of the STB 2 are connected and that serves to control operation.

While the user is watching the content (or channel) CP, the receive module 20 is arranged to receive an audio and video data signal making up the main content CP.

The module 28 is arranged to receive infrared or RF signals from the remote control 5, to interpret and convert these signals into control signals, and to send these control signals to the central unit 33.

In the above description, the equipment STB makes use of an HTTP type request to access the user content present in the NAS and the encoded multimedia contents are sent thereto progressively in the form of an HTTP stream.

In a variant, the streams may be sent from a video on demand (VOD) server using an adaptive progressive downloading technique known as “HTTP adaptive streaming”

(HAS), likewise based on the HTTP protocol. This type of technique makes it possible in particular to give the user good quality content while taking account of bandwidth variations that may occur in the connection between the client terminal (7) and the service gateway (6) or between the service gateway and the content server (3a).

In another variant, the STB directly accesses the contents of a digital medium to which it is connected, e.g. a universal serial bus (USE) stick.

In yet another variant, the Internet group management protocol (IGMP) may be used for requesting reception or stopping of a multicast stream. It is possible to envisage using some other protocol instead of the IGMP protocol.

FIG. 4 is a flow chart showing the various steps of the method in an implementation of the invention.

References E20, E30, and E40 designate prior steps of creating and storing the table T of associations described with reference to FIG. 2. The association between combinations of keys and an action may be defined by the operator/manufacturer of the STB (above Table 1 described with reference to FIG. 2), or it may be personalized by the user (above Table 2 described with reference to FIG. 2); under such circumstances, and as explained with reference to FIG. 2, a configuration page may be made available to the user via a menu of the STB (and displayed on the TV (7)), thus enabling the user to personalize key shortcuts, e.g. when putting the STB into service. This optional step is marked by dashed lines.

During a step E31, the user requests the main content CP. Typically this is a multimedia content (e.g. a film) that is to be found on one of the terminals of the local network, e.g. the user's NAS (3b), or the gateway (6), a PC, etc.

During a step E21, the module 20 of the STE (2) receives this request, analyses it, and seeks to receive content from the local network by sending a message to the gateway, referenced in this example “CP_GET”. The request in this example is processed by the home gateway which manages the local network; in a variant, the content management module may be located directly in the STB.

Reference E22 designates the step comprising subsequent operations of receiving, decoding, and unscrambling the main content CP by the STP 2. The term “main content” is used to mean the (video) content (as contrasted with some other content corresponding to an option (subtitles, etc.)).

By default, the audio is in French.

The main content CP, once it has been decoded and possibly unscrambled, is sent to the playback device 7 by the STB 2 via its module 31.

During a step E41, the new main content CP is received, viewed, and displayed on the screen of the display device 7.

It is now assumed that while the user is watching the content CP during step E32, the user seeks to display subtitles in Spanish by pressing on specific keys of the remote control 5, e.g. the red key (R) as predefined during step E30, or indeed on a succession of keys of the type “S,T” and “E,S”. This action is received by the STB during the step E23. The program of the invention installed on the STB receives the characters “S”, “T”, “E”, and “S”. A timer T setting a predefined duration TMAX (e.g. one second), which may be set either by the manufacturer of the STB or by the user or by any other means, is started each time a new character is received. If the following character is not received within that time lapse, the action is interrupted and the method moves on to step E24.

During step E24, the STB (2) analyses the action performed on the remote control on the basis of the character string it has received, and if it has at least one character for the secondary content type, it interrogates the table in memory. If the preamble corresponds to a known type, i.e. a type that can be identified in the table (first column of Table 1 in the example of FIG. 2), then it reads the remainder of the string, corresponding to the user selecting some possible element (except when the selection is set to default). In this example, it reads the string “ES”, which corresponds to the ISO code for the Spanish language, and it deduces that it is to obtain subtitles in Spanish:
either by acting during step E25 to send a request to the network (STES_GET) via the home gateway (6);
or else by reading the subtitles string that it already possesses: this applies for example with certain audio video file formats that contain a plurality of subtitle tracks in the file (.mkv format).

During a step E26, the subtitles are decoded and sent to the screen (STES_DEC), e.g. via an HDMI connection.

During a step E42, the subtitles are displayed on the screen, e.g. in the form of an overlay in the image of the main content CP.

Naturally, the above-described implementation is given purely by way of non-limiting indication, and numerous modifications may easily be provided by the person skilled in the art without thereby going beyond the ambit of the invention.

In a variant, it is possible to envisage broadcasting audio video contents from VOD platforms, or purely audio contents from audio platforms, digital radio, etc.

In a variant, it is also possible to envisage the user making use of the remote control of the TV, with the TV sending appropriate orders (option selection) to the decoder (STB), in particular making use of the HDMI/CEC standard.

1. A method of selecting secondary multimedia contents associated with a main multimedia content being played back by a playback device the contents being stored in a network and controlled by a remote control device, the method comprising the following acts:
playing back the main multimedia content on the playback device;
detecting an action on the remote control device;
accessing the secondary content corresponding to said action; and
playing back the secondary content with the main content on the playback device;
wherein accessing the secondary content is preceded by an act of obtaining data for matching the action on the remote control device with the secondary content.

2. The method according to claim 1, wherein the action on the remote control device is selecting at least two keys of the remote control.

3. The method according to claim 2, wherein two keys on the remote control must be selected in succession within a predefined maximum duration.

4. The method according to claim 2, wherein at least one selected key corresponds to secondary content type data (“L”, “ST”) and enables the action on the remote control device to be matched with the secondary content.

5. The method according to claim 1, wherein the data for matching the action on the remote control device with the secondary content to be selected is stored in a correspondence data structure in memory in at least a terminal of the network.

6. The method according to claim 5, wherein the correspondence data structure in the memory of the terminal is modified by the user by using an interface.

7. A device for selecting a secondary multimedia content associated with a main multimedia content played back on a playback device, the contents being stored in a network and being capable of being controlled by a remote control device, the device for selecting content comprising the following modules:
a playback module playing back the main multimedia content on the playback device;
a detection module for detecting an action on the remote control device;
an access module for accessing the secondary content corresponding to said action;
a playback module playing back the secondary content with the main content;
a module matching the action on the remote control device with the secondary content; and
a processor, which is configured to implement at least one of the modules.

8. A communication terminal including a device according to claim 7.

9. The communication terminal according to claim 8, wherein the communication terminal includes a receive module configured to receive an action from the playback device, said action being transmitted from a remote control device associated with the playback device.

10. A non-transitory computer-readable medium comprising a computer program stored thereon and including software instructions for controlling execution of a method when the program is executed by a computer, wherein the instructions configure the computer to perform acts of:
selecting secondary multimedia contents associated with a main multimedia content being played back by a playback device, the contents being stored in a network and controlled by a remote control device, wherein selecting comprises:
playing back the main multimedia content on the playback device;
detecting an action on the remote control device;
accessing the secondary content corresponding to said action; and
playing back the secondary content with the main content on the playback device;
wherein accessing the secondary content is preceded by obtaining data for matching the action on the remote control device with the secondary content.
